(19) United States
(12) Patent Application Publication
(10) Pub. No.: US 2026/0073670 A1
(43) Pub. Date: Mar. 12, 2026

(54) AUDIO-VISUAL REPRESENTATION LEARNING FOR LIP-SYNC ESTIMATION THROUGH RANKING AUGMENTED CONTRASTIVE TRAINING

(71) Applicant: NETFLIX, INC., Los Gatos, CA (US)

(72) Inventors: Bhavin JAWADE, San Jose, CA (US); Ravi Teja GADDE, Jersey City, NJ (US); Christophe Bou Hatab EL BEJJANI, Seattle, WA (US); Yinghong LAN, Los Gatos, CA (US)

(21) Appl. No.: 19/319,398

(22) Filed: Sep. 4, 2025

Related U.S. Application Data
(60) Provisional application No. 63/691,656, filed on Sep. 6, 2024.

(51) Int. Cl. G06V 10/774; G06V 20/40; G06V 40/16; G06V 40/20; G10L 25/18; G10L 25/27; G11B 27/10

(52) U.S. Cl. CPC G06V 10/774; G06V 20/40; G06V 40/171; G06V 40/20; G11B 27/10; G10L 25/18; G10L 25/27

(57) ABSTRACT

One embodiment sets forth a technique for performing multi-stage training of lip-sync estimation models. According to some embodiments, the method can be implemented by a computing device, and includes the steps of obtaining video training data comprising a plurality of training videos and corresponding audio training data; training a machine learning (ML) model for lip-sync estimation through a plurality of training stages, where each successive stage utilizes training data having greater synchronization complexity than a preceding training stage; updating parameters of the ML model based on results generated from the plurality of training stages; and generating a trained lip-sync estimation model based on the updated parameters of the ML model.

### CROSS-REFERENCE TO RELATED APPLICATIONS

This application claims priority benefit of the United States Provisional Patent Application titled “AUDIO-VISUAL REPRESENTATION LEARNING FOR LIP-SYNC ESTIMATION THROUGH RANKING AUGMENTED CONTRASTIVE TRAINING” filed on Sep. 6, 2024, and having Serial No. U.S. 63/691,656. The subject matter of this related application is hereby incorporated herein by reference.

### BACKGROUND

### Field of the Various Embodiments

Embodiments of the present disclosure relate generally to computer science, artificial intelligence, and audio-visual media, and, more specifically, to audio-visual representation learning for lip-sync estimation through ranking augmented contrastive training.

### Description of the Related Art

Audio-visual synchronization assessment represents a fundamental challenge in multimedia processing and content production workflows. Evaluation of the temporal alignment between audio and visual components of media content serves as an important function for content producers and distributors. Temporal misalignments can arise, for example, when an incorrect audio track is matched to a particular video or when a correct audio track is temporally out-of-sync with a particular video. Such synchronization problems can occur during various stages of production and distribution pipelines, including filming, editing, and content streaming. As the scale of content production and distribution continues to expand into wider formats and languages, the use of automated audio-visual synchronization assessment is increasing.

Conventional approaches to audio-visual synchronization have focused on training machine learning models to identify alignment or misalignment between spoken words and corresponding lip movements in media content, which is commonly referred to as lip-sync estimation. Lip-sync estimation training approaches involve training machine learning models to succeed at the binary classification task of distinguishing between perfectly synchronized media content and unsynchronized media content through contrastive learning. Training data for such contrastive learning approaches is generated by using perfectly synchronized media content and replacing the audio content with random or unrelated audio content. Based on the synchronized and unsynchronized media content, the lip-sync estimation model learns to determine when lip movement in the visual content aligns with the audio content.

One technical drawback of conventional contrastive learning approaches for training lip-sync estimation models involves failure to accurately assess varying degrees of partial synchronization. Traditional contrastive learning approaches generate embedding spaces optimized for binary discrimination. Consequently, lip-sync estimation models trained with traditional approaches fail to provide meaningful differentiation among partially synchronized content. This limitation is particularly problematic when evaluating the synchronization of dubbed audio content. Specifically, dubbed audio content naturally exhibits partial synchronization between lip movements and audio, as dubbed dialogue aligns with moments when the speaker speaks in the original content. However, lip-sync estimation models trained with traditional contrastive learning approaches are not designed to learn the subtle distinctions between synchronized and unsynchronized dubbed content. Therefore, existing lip-sync estimation models are unable to effectively identify misalignments between visual and audio content in the context of dubbed content.

Another technical drawback of conventional contrastive learning approaches for training lip-sync estimation models involves the lack of understanding and utilization of partial-sync examples. Conventional contrastive learning approaches enforce binary classification between synchronized content and unsynchronized content formed by randomly pairing audio and video channels. In reality, a continuum of synchronization levels exists, both temporally (e.g., audio and visual content displaced by a single frame or two frames) and linguistically (e.g., audio dubs of varying quality and in differing languages). By ignoring such a continuum of synchronization, conventional approaches both learn an incomplete understanding of audio-visual synchronization and neglect available training data that could improve performance.

As the foregoing illustrates, what is needed in the art are more effective techniques for training lip-sync estimation models.

### SUMMARY

In various embodiments, a computer-implemented method for training lip-sync estimation models includes obtaining video training data comprising a plurality of training videos and corresponding audio training data; selecting an anchor video from the plurality of training videos; identifying, with respect to the anchor video and based on a similarity evaluation generated by a machine learning (ML) model, a plurality of audio samples; generating a training loss from the plurality of audio samples; applying backpropagation from the training loss to update parameters of the ML model until a convergence criteria is satisfied; and generating a trained lip-sync estimation model based on the updated parameters.

In various embodiments, a computer-implemented method for performing multi-stage training of lip-sync estimation models includes obtaining video training data comprising a plurality of training videos and corresponding audio training data; training a machine learning (ML) model for lip-sync estimation through a plurality of training stages, where each successive stage utilizes training data having greater synchronization complexity than a preceding training stage; updating parameters of the ML model based on results generated from the plurality of training stages; and generating a trained lip-sync estimation model based on the updated parameters of the ML model.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques enable the ranking and fine-grained assessment of partial synchronization in audio-visual content, which presented challenges under conventional contrastive learning approaches. More specifically, conventional lip-sync estimation models generate binary embedding spaces that distinguish only between perfectly synchronized and unsynchronized content. Such a limitation renders the evaluation of intermediate synchronization levels, in the context of dubbing, prohibitively difficult. The disclosed Ranking Supervised Multi-Similarity (RSMS) loss function forces the model to learn a continuous spectrum of synchronization quality. This enables the model to distinguish dubbed audio tracks from perfectly synchronized and unsynchronized audio tracks. The multi-stage training approach incorporates partially-synchronized training examples of increasing complexity at multiple stages. Such a strategy assists the lip-sync estimation model in learning a continuum of lip-sync synchronization. As a result, the disclosed training approach trains a lip-sync estimation model that is capable of automated estimation of dubbed content, a task that was previously technically challenging to implement.

Another technical advantage of the disclosed techniques over the prior art is that the disclosed techniques utilize partially-synchronized examples to increase the volume of training data. Conventional contrastive learning approaches enforce a binary classification between perfectly synchronized and unsynchronized content. Because the training procedure lacks an understanding of partially-synchronized content, partially synchronized content does not provide usefulness for training lip-sync estimation models in these approaches. The disclosed techniques make use of real-world partially-synchronized content with the RSMS loss function and the multi-stage training procedure. As a result, the disclosed techniques use partially-synchronized content more efficiently for training data and therefore generate more accurate and expressive lip-sync estimation models.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a block diagram illustrating the machine learning server 110 of FIG. 1 in greater detail, according to various embodiments.

FIG. 3 provides a detailed illustration of the lip-sync estimation model 146 described in conjunction with FIG. 1, according to various embodiments.

FIG. 4 provides a detailed illustration of the model trainer described in conjunction with FIG. 1, according to various embodiments.

FIG. 5 provides a more detailed illustration of the hard example miner described in conjunction with FIG. 4, according to various embodiments.

FIG. 6 sets forth a flow diagram of method steps for training a lip-sync estimation model using ranking-supervised multi-similarity (RSMS) loss, according to various embodiments.

FIG. 7 sets forth a flow diagram of method steps for multi-stage training of a lip-sync estimation model using a multi-stage training procedure of increasing synchronization complexity, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Audio-visual synchronization assessment represents a fundamental challenge in multimedia processing and content production workflows. Evaluation of the temporal alignment between audio and visual components of media content serves as an important function for content producers and distributors. Temporal misalignments can arise, for example, when an incorrect audio track is matched to a particular video or when a correct audio track is temporally out-of-sync with a particular video. Such synchronization problems can occur during various stages of production and distribution pipelines, including filming, editing, and content streaming. As the scale of content production and distribution continues to expand into wider formats and languages, the use of automated audio-visual synchronization assessment is increasing.

Conventional approaches to audio-visual synchronization have focused on training machine learning models to identify alignment or misalignment between spoken words and corresponding lip movements in media content, which is commonly referred to as lip-sync estimation. Lip-sync estimation training approaches involve training machine learning models to succeed at the binary classification task of distinguishing between perfectly synchronized media content and unsynchronized media content through contrastive learning. Training data for such contrastive learning approaches is generated by using perfectly synchronized media content and replacing the audio content with random or unrelated audio content. Based on the synchronized and unsynchronized media content, the lip-sync estimation model learns to determine when lip movement in the visual content aligns with the audio content.

One technical drawback of conventional contrastive learning approaches for training lip-sync estimation models involves failure to accurately assess varying degrees of partial synchronization. Traditional contrastive learning approaches generate embedding spaces optimized for binary discrimination. Consequently, lip-sync estimation models trained with traditional approaches fail to provide meaningful differentiation among partially synchronized content. This limitation is particularly problematic when evaluating the synchronization of dubbed audio content. Specifically, dubbed audio content naturally exhibits partial synchronization between lip movements and audio, as dubbed dialogue aligns with moments when the speaker speaks in the original content. However, lip-sync estimation models trained with traditional contrastive learning approaches are not designed to learn the subtle distinctions between synchronized and unsynchronized dubbed content. Therefore, existing lip-sync estimation models are unable to effectively identify misalignments between visual and audio content in the context of dubbed content.

Another technical drawback of conventional contrastive learning approaches for training lip-sync estimation models involves the lack of understanding and utilization of partial-sync examples. Conventional contrastive learning approaches enforce binary classification between synchronized content and unsynchronized content formed by randomly pairing audio and video channels. In reality, a continuum of synchronization levels exists, both temporally (e.g., audio and visual content displaced by a single frame or two frames) and linguistically (e.g., audio dubs of varying quality and in differing languages). By ignoring such a continuum of synchronization, conventional approaches both learn an incomplete understanding of audio-visual synchronization and neglect available training data that could improve performance.

To address these issues, the disclosed techniques are directed toward the implementation of audio-visual models for lip-sync estimation. The purpose is to facilitate the ranking and assessment of partial synchronization in dubbed content. More specifically, in various embodiments, the disclosed techniques involve training a lip-sync estimation model initially. This involves contrastive pre-training using positive and negative audio-video pairs to establish a foundational understanding of synchronization. Subsequently, the techniques include fine-tuning the model through a ranking-based approach using synthetic shifted synchronizations to introduce supervision for partial synchronization. A final fine-tuning step employs real-world dubbed audio as examples of partial synchronization. Furthermore, the disclosed techniques, at all stages of pre-training and fine-tuning, apply a Ranking Supervised Multi-Similarity (RSMS) loss function. This loss function incorporates hierarchical supervision through hard-sample mining to enforce ranking among perfectly synced, partially synced, and unsynced audio-visual pairs. During training, the techniques compute weighted loss terms for each mined category of hard samples. This computation enables a fine-grained assessment of synchronization quality across the continuum of synchronization.

One technical advantage of the disclosed techniques over the prior art is that the disclosed techniques enable the ranking and fine-grained assessment of partial synchronization in audio-visual content, which presented challenges under conventional contrastive learning approaches. More specifically, conventional lip-sync estimation models generate binary embedding spaces that distinguish only between perfectly synchronized and unsynchronized content. Such a limitation renders the evaluation of intermediate synchronization levels, in the context of dubbing, prohibitively difficult. The disclosed Ranking Supervised Multi-Similarity (RSMS) loss function forces the model to learn a continuous spectrum of synchronization quality. This enables the model to distinguish dubbed audio tracks from perfectly synchronized and unsynchronized audio tracks. The multi-stage training approach incorporates partially-synchronized training examples of increasing complexity at multiple stages. Such a strategy assists the lip-sync estimation model in learning a continuum of lip-sync synchronization. As a result, the disclosed training approach trains a lip-sync estimation model that is capable of automated estimation of dubbed content, a task that was previously technically challenging to implement.

Another technical advantage of the disclosed techniques over the prior art is that the disclosed techniques utilize partially-synchronized examples to increase the volume of training data. Conventional contrastive learning approaches enforce a binary classification between perfectly synchronized and unsynchronized content. Because the training procedure lacks an understanding of partially-synchronized content, partially synchronized content does not provide usefulness for training lip-sync estimation models in these approaches. The disclosed techniques make use of real-world partially-synchronized content with the RSMS loss function and the multi-stage training procedure. As a result, the disclosed techniques use partially-synchronized content more efficiently for training data and therefore generate more accurate and expressive lip-sync estimation models.

These technical advantages provide one or more technological advancements over prior art approaches.

### System Overview

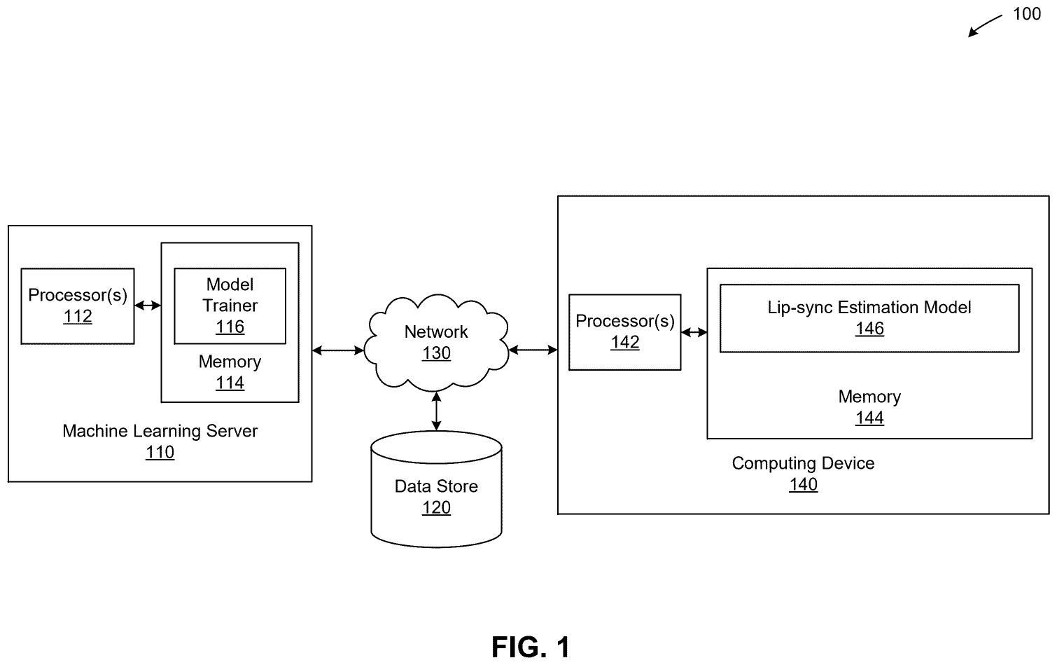

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130. The network 130 can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110 that control and coordinate operations of other system components. In particular, the processor(s) 112 can issue commands that control the operation of one or more graphics processing units (GPUs) (not shown) and/or other parallel processing circuitry, such as parallel processing units or deep learning accelerators, that incorporate circuitry optimized for graphics and video processing. Such circuitry includes, for example, video output circuitry. The GPU(s) can deliver pixels to a display device that can be any conventional cathode ray tube, liquid crystal display, light-emitting diode display, and/or similar devices.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, adjustments can be made regarding the number of processors 112, the number of GPUs and/or other processing unit types, the number of system memories 114, and/or the number of applications included in the system memory 114. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment. Such an environment can be a public, private, or a hybrid cloud system.

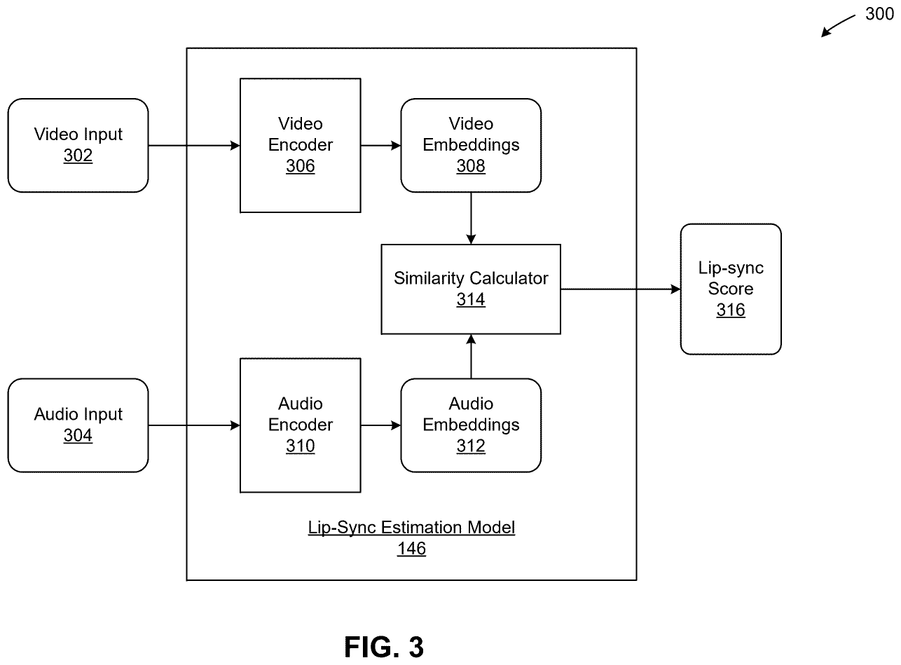

In some embodiments, the model trainer 116 is configured to train one or more machine learning models, including a lip-sync estimation model 146. Techniques that the model trainer 116 can use to train the machine learning model(s) are discussed in greater detail below in conjunction with FIGS. 3-7. Training data and/or trained (or deployed) machine learning models can be stored in the data store 120. In some embodiments, the data store 120 can include any storage device or devices, such as fixed disc drives, flash drives, optical storage, network-attached storage (NAS), and/or a storage area network (SAN). Although shown as accessible over the network 130, in at least one embodiment, the machine learning server 110 can include the data store 120.

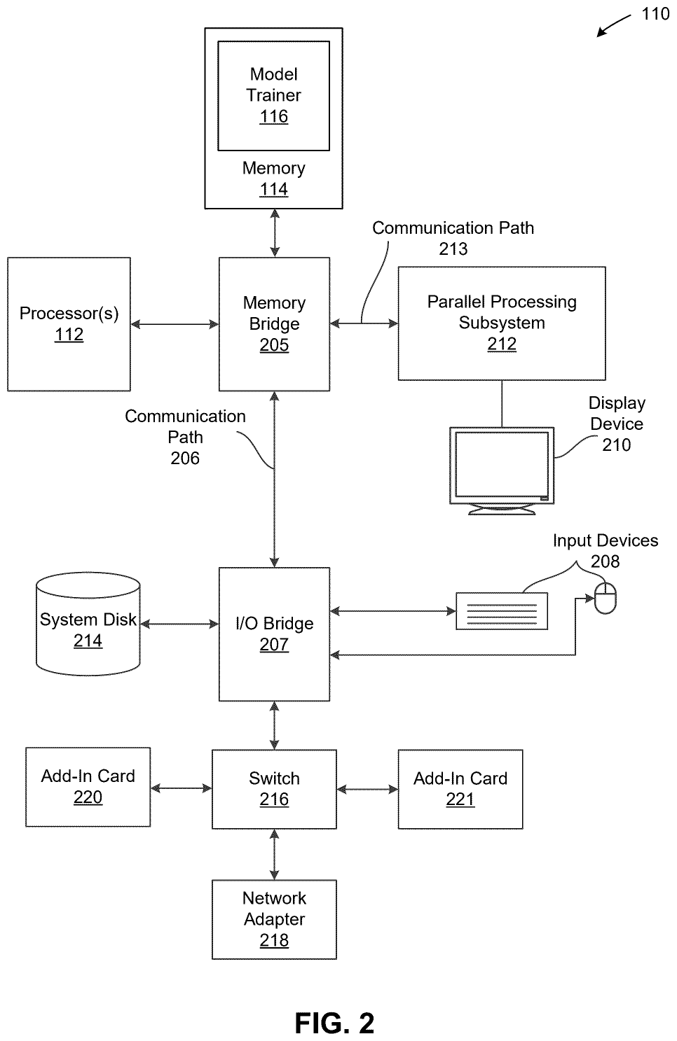

FIG. 2 is a block diagram illustrating the machine learning server 110 of FIG. 1 in greater detail, according to various embodiments. Machine learning server 110 may be any type of computing system, including, without limitation, a server machine, a server platform, a desktop machine, a laptop machine, a handheld/mobile device, a digital kiosk, or a wearable device. In some embodiments, machine learning server 110 is a server machine operating in a data center or a cloud computing environment that provides scalable computing resources as a service over a network.

In various embodiments, machine learning server 110 includes, without limitation, the processor(s) 112 and the memory (IES) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, machine learning server 110 may be a server machine in a cloud computing environment. In such embodiments, machine learning server 110 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add-in cards 220 and 221.

In some embodiments, I/O bridge 207 is coupled to a system disk 214 that may be configured to store content and applications and data for use by processor(s) 112 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid-state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within machine learning server 110, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized for general-purpose and/or compute processing. Again, such circuitry may be incorporated across one or more PPUs included within parallel processing subsystem 212 that are configured to perform such general-purpose and/or compute operations. In yet other embodiments, the one or more PPUs included within parallel processing subsystem 212 may be configured to perform graphics processing, general-purpose processing, and/or compute processing operations.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on a chip (SoC).

System memory 114 includes at least one device driver configured to manage the processing operations of the one or more PPUs within parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In some embodiments, processor(s) 112 includes the primary processor of machine learning server 110, controlling and coordinating operations of other system components. In some embodiments, the processor(s) 112 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Ranking Augmented Contrasted Training

FIG. 3 provides a detailed illustration of the lip-sync estimation model 146 described in conjunction with FIG. 1, according to various embodiments. As shown in FIG. 3, the lip-sync estimation model 146 includes a video encoder 306, an audio encoder 310, and a similarity calculator 314. In some embodiments, the video encoder 306, the audio encoder 310, and the similarity calculator 314 operate sequentially to generate a lip-sync score 316 from a video input 302 and an audio input 304.

In some embodiments, the video input 302 consists of a sequence of frames extracted from video content. In some embodiments, the video input 302 is cropped to focus on the face and lip region of persons on screen to enable accurate synchronization analysis. The audio input 304 consists of a spectrogram of a recorded audio signal. In some embodiments, the audio input 304 is processed via a transformation for enhanced resolution of frequency ranges corresponding to human voices, for example a mel-frequency cepstrum (MFC). The video input 302 and the audio input 304 represent sequences of the same temporal length. The audio input 304 may correspond to the original source audio for the video input 302, but not in all applications and embodiments. For example, during training, some examples of the audio input 304 will correspond to the video input 302, while others will be derived from source audio from a random, unrelated recording.

In some embodiments, the video encoder 306 accepts the video input 302 as input and generates the video embeddings 308 as output. The video encoder 306 is a machine learning model with learnable parameters that transforms spatial and temporal information in the video input 302 into a dense embedding representation encoding features related to synchronization in the video embedding 308. During training, the video encoder 306 learns to identify properties of the video frames comprising the video input 302 that are relevant to computing synchronization. For example, in some embodiments, the video encoder 306 learns to identify the shape and timing of various lip movements by the speaker and encodes such information in the video embedding 308. In at least one embodiment, the video encoder 306 includes a convolutional neural network component for spatial feature extraction and a transformer-based component for a temporal model of spatial features.

In some embodiments, the audio encoder 310 accepts the audio input 304 as input and generates the audio embeddings 312 as output. The audio encoder 310 is a machine learning model with learnable parameters that transforms frequency and temporal information in the audio input 304 into a dense embedding representation encoding features related to synchronization in the audio embedding 312. During training, the audio encoder 310 learns to identify properties in the audio spectrogram comprising the audio input 304 that are relevant to computing synchronization. For example, in some embodiments, the audio encoder 310 learns to identify the timing and different sounds generated by the speaker and encodes such information in the audio embedding 312. In at least one embodiment, the audio encoder 310 includes a convolutional neural network component for frequency feature extraction and a transformed-based component for a temporal model of audio features.

In some embodiments, the similarity calculator 314 accepts the video embeddings 308 and the audio embeddings 312 as inputs and generates the lip-sync score 316 as output. The similarity calculator 314 computes a numeric score that measures the similarity between the video embeddings 308 and the audio embeddings 312 to quantify the degree of synchronization between visual lip movements and corresponding audio content. In some embodiments, a cosine similarity is used to compute the score. In some embodiments, the similarity calculator 314 computes a normalized dot-product of the video embeddings 308 and the audio embeddings 312 to produce the lip-sync score 316. In some embodiments, the lip-sync score 316 is the final output of the lip-sync estimation model 146, and provides a quantitative assessment of the audio-visual synchronization. A lip-sync score 316 value close to one represents a high level of synchronization between the video input 302 and the audio input 304 according to the lip-sync estimation model 146. A lip-sync score close to negative one represents a low level of synchronization between the video input 302 and the audio input 304 according to the lip-sync estimation model 146.

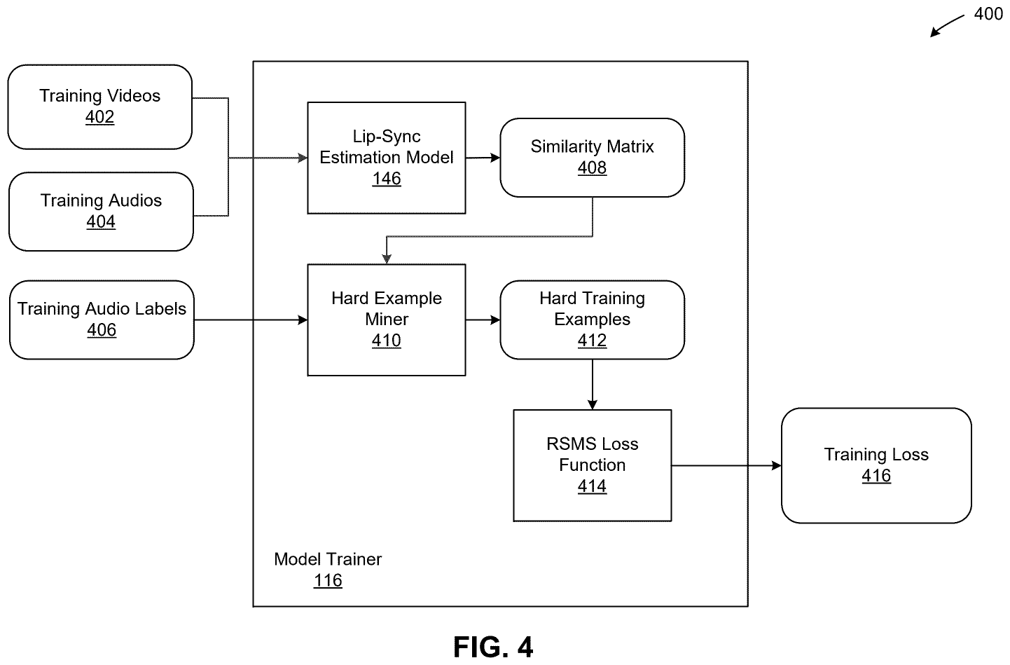

FIG. 4 provides a detailed illustration of the model trainer 116 described in conjunction with FIG. 1, according to various embodiments. As shown in FIG. 4, the model trainer 116 includes lip-sync estimation model 146, a hard example miner 410, and an RSMS loss function 414. In some embodiments, the lip-sync estimation model 146, the hard example miner 410, and the RSMS loss function 414 operate sequentially to generate the training loss 416 from the training videos 402, the training audios 404, and the training audio labels 406.

In some embodiments, the training videos 402 consist of video sequences containing facial regions and lip movements that serve as the visual training data for the lip-sync estimation model 146. The training audios 404 consist of spectrograms of audio content that serve as the audio training data for the lip-sync estimation model 146. In some embodiments, at various stages of training, the training audios 404 may consist of source audios from the training videos 402, dubbed audios from the training videos 402, manually de-synced source audios from the training videos 402, or combination thereof.

In some embodiments, the training audio labels 406 provide categorical information that identifies the synchronization relationship between each unit of the training videos 402 and the training audios 404. The training audio labels 406 specify whether a given training audio 404 is the source audio of a training video 402, and if so which training video 402. In some embodiments, the training audio labels 406 also identify whether a training audio 404 corresponds to dubbed audio content or manually de-synced source audios as well.

In some embodiments, the lip-sync estimation model 146 accepts the training videos 402 and the training audios 404 as input and produces the similarity matrix 408 as output. The lip-sync estimation model 146 accepts a training video 402 and a training audio 404 and produces a lip-sync score 316, as described in greater detail above in conjunction with FIG. 3. In the context of the model trainer 116, the lip-sync estimation model 146 computes a lip-sync score 316 for every audio-video pair in the training videos 402 and the training audios 404. In some embodiments, rather than computing lip-sync scores 316 for all possible combinations of training videos 402 and training audios 404, sub-setting and batching is performed to reduce the computation required. In some embodiments, the lip-sync estimation model computes the video embeddings 308 and the audio embeddings 312 for each training video 402 and training audio 404, respectively, and the lip-sync score 316 is computed from these embeddings to avoid repeated computations for efficiency. The result of this process is a lip-sync score 316 for each audio-video pair in the training videos 402 and the training audios 404. This matrix of lip-sync scores 316 composes the similarity matrix 408.

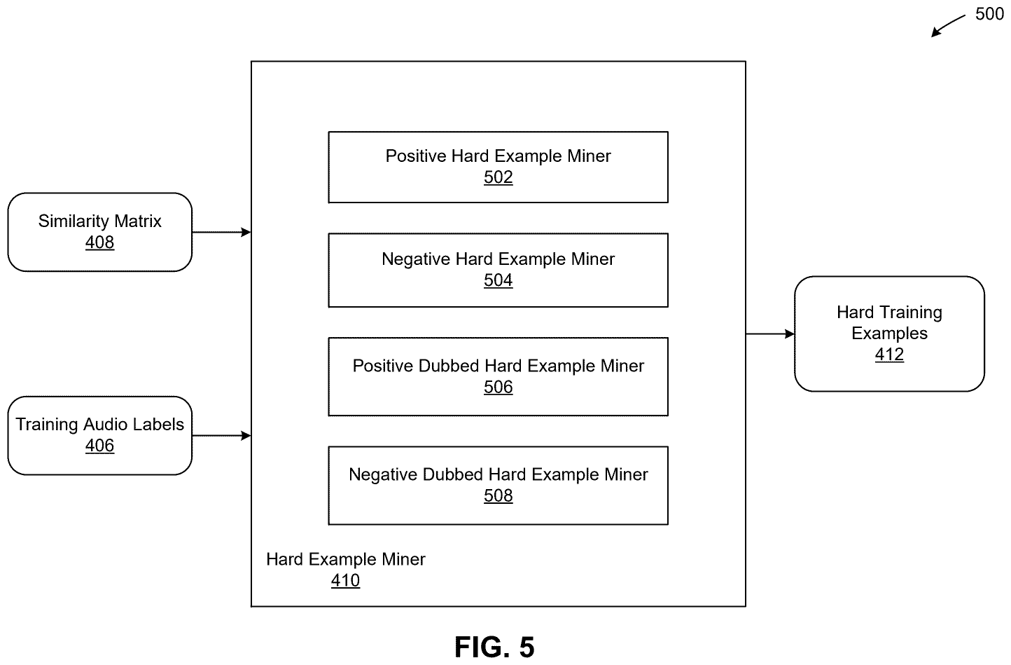

In some embodiments, the hard example miner 410 accepts the similarity matrix 408 and the training audio labels 406 as inputs and generates the hard training examples 412 as output. The hard example miner 410 implements adaptive sampling strategies that identify pairs of the training videos 402 and the training audios 404 providing maximal learning signal for ranking-based supervision, as described in greater detail below in conjunction with FIG. 5. The hard example miner 410 analyzes similarity scores within the similarity matrix 408 along with the categorical information from the training audio labels 406 to identify four distinct categories of hard examples. In some embodiments, the hard example miner 410 identifies hard positive examples, which are synchronization matches that the lip-sync estimation model 146 has poorly identified; hard negative examples; hard dubbed examples relative to positives, which are dubbed synchronization matches that the lip-sync estimation model 146 has poorly identified relative to positive audios; and hard dubbed examples relative to negatives. The hard example miner 410 filters the full set of training videos 402 and training audios 404 down to a set of hard examples within each of these categories and returns these examples as the hard training examples 412.

In some embodiments, the RSMS loss function 414 accepts the hard training examples 412 as input and generates the training loss 416 as output. The RSMS loss function 414 implements ranking-supervised multi-similarity loss computation that enforces hierarchical relationships between different synchronization categories through four distinct loss terms. The RSMS loss function 414 computes the following four terms:

$${L}^{{p}_{i}} = log ( 1 + exp ( - α ( {\hat{S}}^{{p}_{i}} - σ ) ) ) \qquad [ 1 ]$$

$${L}^{{n}_{i}} = log ( 1 + exp ( β ( {\hat{S}}^{{n}_{i}} - σ ) ) ) \qquad [ 2 ]$$

$${L}^{p {r}_{i}} = log ( 1 + exp ( - γ ( {\hat{S}}^{p {r}_{i}} - σ ) ) ) \qquad [ 3 ]$$

$${L}^{{nr}_{i}} = log ( 1 + exp ( δ ( {\hat{S}}^{{nr}_{i}} - σ ) ) ) \qquad [ 4 ]$$

$${L}_{RSMS} = ( 1 / B ) {\sum }^{{B}_{( i = 1 )}} [ ( 1 / α ) {L}^{{p}_{i}} + ( 1 / β ) \times {L}^{{n}_{i}} + ( 1 / γ ) \times {L}^{p {r}_{i}} + ( 1 / δ ) \times {L}^{{nr}_{i}} ] \qquad [ 5 ]$$

Where Ŝ^{p}ᵢ, Ŝⁿᵢ, Ŝ^{pr}ᵢ, Ŝ^{nr}ᵢ represent the hard positive, hard negative, hard dubbed with respect to positive, and hard dubbed with respect to negative similarities, respectively, and α, β, γ, δ are corresponding training constants, and σ is a threshold constant. The RSMS loss function 414 enables the model trainer 116 to train the lip-sync estimation model 146 to learn continuous representations of synchronization quality through enforcement of ranking relationships between perfect synchronization, dubbed examples, and unsynchronized examples. After computing the total loss LRSMS, the RSMS loss function 414 returns LRSMS as the training loss 416. During training the training loss 416 is used to update the parameters of the lip-sync estimation model 146.

FIG. 5 provides a more detailed illustration of the hard example miner 410 described above in conjunction with FIG. 4, according to various embodiments. As shown in FIG. 5, the hard example miner 410 includes a positive hard example miner 502, a negative hard example miner 504, a positive dubbed hard example miner 506, and a negative dubbed hard example miner 508. In some embodiments, the positive hard example miner 502, the negative hard example miner 504, the positive dubbed hard example miner 506, and the negative dubbed hard example miner 508 operate in sequence to generate the hard training examples 412, using the similarity matrix 408 and the training audio labels 406 as input.

In some embodiments, the positive hard example miner 502 accepts the similarity matrix 408 and the training audio labels 406 as inputs and identifies positive hard examples returned as a component of the hard training examples 412. The positive hard example miner 502 identifies hard positive examples by first iterating through the similarity scores for each video in the similarity matrix 408, iteratively selecting each video as the “anchor video.” The training audio labels 406 are used to identify each audio compared to the anchor video as a positive/source audio, a negative audio, or a dubbed audio. For each row corresponding to an anchor video in the similarity matrix 408, the positive hard example miner 502 identifies positive audios (i.e., audio that is the true source audio of the anchor video) with similarity scores that are lower than at least one negative or dubbed example for that same anchor video. In some embodiments, a threshold constant λ is subtracted from the positive similarity scores before the comparison to negative and dubbed similarity scores. The identified positive audios with lower similarity scores are selected as positive hard examples. After the positive hard examples are identified for each anchor video, such examples are returned as a component of the hard training examples 412.

In some embodiments, the negative hard example miner 504 accepts the similarity matrix 408 and the training audio labels 406 as inputs and identifies negative hard examples returned as a component of the hard training examples 412. The negative hard example miner 504 identifies hard negative examples by first iterating through the similarity scores for each video in the similarity matrix 408, iteratively selecting each video as the “anchor video.” The training audio labels 406 are used to identify each audio compared to the anchor video as a positive/source audio, a negative audio, or a dubbed audio. For each row corresponding to an anchor video in the similarity matrix 408, the negative hard example miner 504 identifies negative audios (i.e., audio that is not the true source audio or a dub of the anchor video) with similarity scores that are higher than at least one positive or dubbed example for that same anchor video. In some embodiments, a threshold constant λ is added to the negative similarity scores before the comparison to positive and dubbed similarity scores. The identified negative audios with higher similarity scores are selected as negative hard examples. After the negative hard examples are identified for each anchor video, such examples are returned as a component of the hard training examples 412.

In some embodiments, the positive dubbed hard example miner 506 accepts the similarity matrix 408 and the training audio labels 406 as inputs and identifies positive dubbed hard examples returned as a component of the hard training examples 412. The positive dubbed hard example miner 506 identifies hard dubbed positive examples by first iterating through the similarity scores for each video in the similarity matrix 408, iteratively selecting each video as the “anchor video.” The training audio labels 406 are used to identify each audio compared to the anchor video as a positive/source audio, a negative audio, or a dubbed audio. For each row corresponding to an anchor video in the similarity matrix 408, the positive dubbed hard example miner 506 identifies dubbed audios (i.e., audio that is the true dubbed audio of the anchor video) with similarity scores that are higher than at least one positive example for that same anchor video. In some embodiments, a threshold constant λd is added to the dubbed similarity scores before the comparison to the positive similarity scores. The identified dubbed audios with lower similarity scores are selected as positive dubbed hard examples. After the positive dubbed hard examples are identified for each anchor video, such examples are returned as a component of the hard training examples 412.

In some embodiments, the negative dubbed hard example miner 508 accepts the similarity matrix 408 and the training audio labels 406 as inputs and identifies negative dubbed hard examples returned as a component of the hard training examples 412. The negative dubbed hard example miner 508 identifies hard dubbed negative examples by first iterating through the similarity scores for each video in the similarity matrix 408, iteratively selecting each video as the “anchor video.” The training audio labels 406 are used to identify each audio compared to the anchor video as a positive/source audio, a negative audio, or a dubbed audio. For each row corresponding to an anchor video in the similarity matrix 408, the negative dubbed hard example miner 508 identifies dubbed audios (i.e., audio that is the true dubbed audio of the anchor video) with similarity scores that are lower than at least one negative example for that same anchor video. In some embodiments, a threshold constant λd is subtracted from the dubbed similarity scores before the comparison to the negative similarity scores. The identified dubbed audios with higher similarity scores are selected as negative dubbed hard examples. After the negative dubbed hard examples are identified for each anchor video, such examples are returned as a component of the hard training examples 412.

In some embodiments, the hard training examples 412 represent the aggregated output from the positive hard example miner 502, the negative hard example miner 504, the positive dubbed hard example miner 506, and the negative dubbed hard example miner 508. By combining hard training examples from four distinct categories, the hard example miner 410 assists in training the lip-sync estimation model 146 by identifying the most challenging examples with the maximum learning signal for the model to learn from.

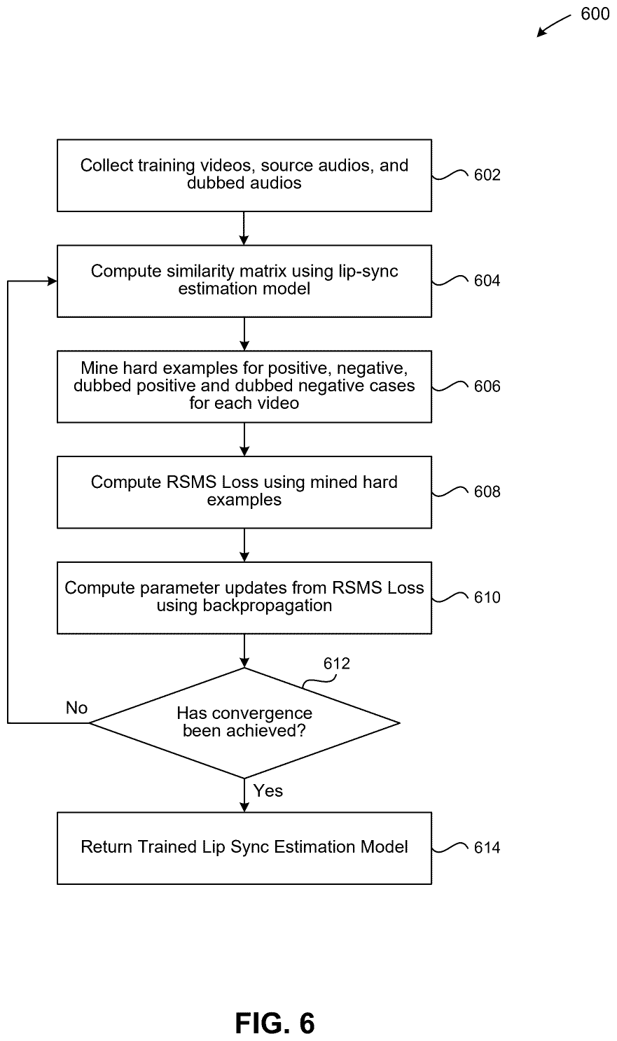

FIG. 6 sets forth a flow diagram of method steps for training a lip-sync estimation model 146 using ranking-supervised multi-similarity (RSMS) loss, according to various embodiments. Although the method steps are described in conjunction with the systems of FIGS. 1-5, persons skilled in the art will understand that any system configured to perform the method steps in any order falls within the scope of the present disclosure.

As shown, the method 600 begins at step 602, where the model trainer 116 collects training videos, source audios, and dubbed audios for training the lip-sync estimation model 146. The model trainer 116 assembles a training dataset that includes training videos 402 containing facial regions and lip movements, and training audio 404, which includes source audio content and dubbed audio content. Additionally, training audio labels 406 are constructed, identifying dubbed training audio 404 and indicating to which training videos 402 each training audio 404 corresponds, if any. In some embodiments, the training videos 402 are pre-processed to extract face regions around speakers to make the training data more suitable for lip-sync identification. In some embodiments, the training audios 404 are pre-processed to generate spectrogram representations that encode frequency and time information of the audio signal in a format compatible with the lip-sync estimation model 146.

At step 604, the model trainer 116 computes the similarity matrix 408 using the lip-sync estimation model 146. The model trainer 116 applies the lip-sync estimation model 146 to process the training videos 402 and the training audios 404 to generate similarity scores between each combination of training videos 402 and training audios 404. This collection of similarity scores is formed into the similarity matrix 408, where each element represents the synchronization score for a given pair of training videos 402 and training audios 404 according to the lip-sync estimation model 146.

At step 606, the model trainer 116 mines hard examples for positive, negative, dubbed with respect to positive, and dubbed with respect to negative cases for each video using the hard example miner 410. These hard examples are extracted to identify, in each class, an example where the lip-sync estimation model 146 is currently generating an incorrect similarity ranking. Such extraction aims to draw maximum training signal from each training step. The model trainer 116 aggregates the output of each of these hard example classes into the hard training examples 412.

At step 608, the model trainer 116 computes the RSMS loss using the mined hard training examples 412. The model trainer 116 applies the RSMS loss function 414 to compute four distinct loss terms corresponding to each of the categories: hard positive, hard negative, hard dubbed with respect to positive, and hard dubbed with respect to negative examples. These four loss terms are aggregated together to generate the training loss 416.

At step 610, the model trainer 116 computes parameter updates for the lip-sync estimation model 146 from the training loss 416 using backpropagation. The model trainer 116 computes the gradient from the training loss 416 and propagates signals from the loss back to the parameters of the lip-sync estimation model 146 using an optimization algorithm, for example, Adam optimization.

At step 612, the model trainer 116 determines whether convergence has been achieved. The model trainer 116 evaluates if pre-defined convergence criteria have been met. For example, in some embodiments, the convergence criteria are defined as a set number of training iterations to perform. In other embodiments, the convergence criteria are determined when consecutive loss updates are sufficiently small. If convergence has not been achieved, the method 600 returns to step 604, and steps 604-612 iterate until convergence criteria are satisfied. If convergence has been achieved, then the method 600 continues to step 614.

At step 614, the model trainer 116 returns the trained lip-sync estimation model 146. The returned lip-sync estimation model 146 has been optimized to properly identify perfectly synchronized, unsynchronized, and partially synchronized audio-video content.

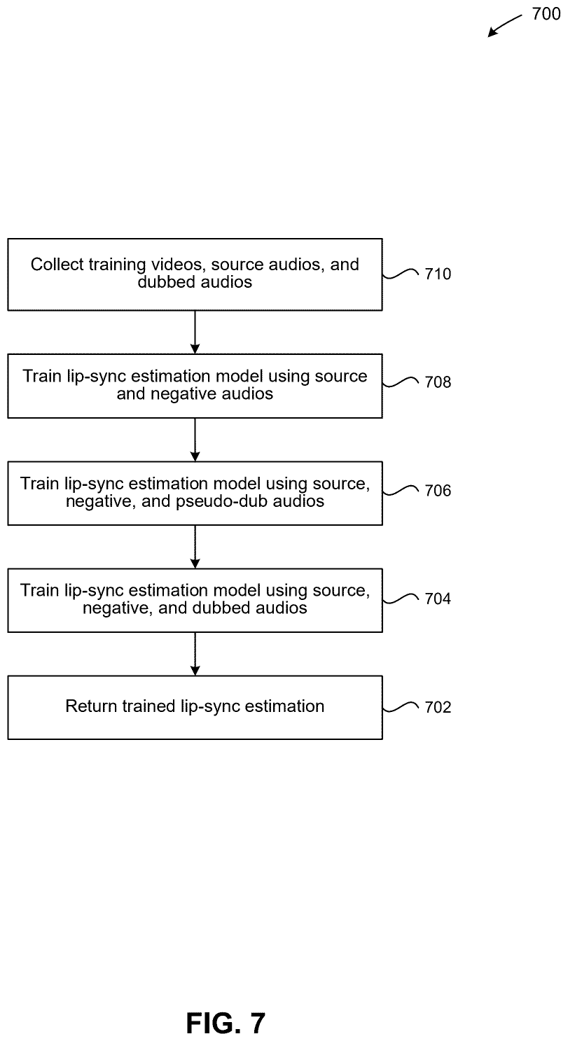

FIG. 7 sets forth a flow diagram of method steps for multi-stage training of a lip-sync estimation model using a multi-stage training procedure of increasing synchronization complexity, according to various embodiments. Although the method steps are described in conjunction with the systems of FIGS. 1-6, persons skilled in the art will understand that any system configured to perform the method steps in any order falls within the scope of the present disclosure.

As shown, method 700 begins at step 702, where the model trainer 116 collects training videos, source audios, and dubbed audios for multi-stage training of the lip-sync estimation model 146. The model trainer 116 assembles a training dataset that includes training videos 402 containing facial regions and lip movements, and training audio 404 that includes source audio content and dubbed audio content. Additionally, training audio labels 406 are constructed, which identify dubbed training audios 404 as well as identify which training videos 402 each training audio 404 corresponds to, if any. In some embodiments, the training videos 402 are pre-processed to extract face regions around speakers to enhance the training data suitability for lip-sync identification. In some embodiments, the training audios 404 are pre-processed to generate spectrogram representations encoding frequency and time information of the audio signal in a format compatible with the lip-sync estimation model 146.

At step 704, the model trainer 116 trains the lip-sync estimation model 146 using only source/positive and negative training audios 404 to establish foundational synchronization understanding. In some embodiments, the model trainer 116 implements an RSMS loss training procedure similar to the one shown in FIG. 6 that includes hard example mining.

At step 706, the model trainer 116 trains the lip-sync estimation model 146 using source/positive, negative, and pseudo-dub audios. Pseudo-dub audios are generated by modifying a source audio by shifting it temporally by a small number of frames. A larger number of frames in the audio shift results in less synchronization between the pseudo-dub audio and the source video. Pseudo-dub audios are introduced to the training procedure to provide a tunable amount of synchronization complexity between synchronized and unsynchronized examples. In some embodiments, the model trainer 116 implements an RSMS loss training procedure similar to the one shown in FIG. 6 that includes hard example mining.

At step 708, the model trainer 116 trains the lip-sync estimation model 146 using source/positive, negative, and dubbed audios. The introduction of dubbed audios at this final training stage introduces real-world synchronization complexity. The model trainer 116 incorporates real-world dubbed audio content that naturally features partial synchronization between source and negative samples. In some embodiments, the model trainer 116 implements an RSMS loss training procedure similar to the one shown in FIG. 6 that includes hard example mining.

At step 710, the model trainer 116 returns the trained lip-sync estimation model 146 with the capability to evaluate a continuum of synchronization levels, including for dubbed content.

In sum, the disclosed techniques are directed toward the implementation of audio-visual models for lip-sync estimation. The purpose is to facilitate the ranking and assessment of partial synchronization in dubbed content. More specifically, in various embodiments, the disclosed techniques involve training a lip-sync estimation model initially. This involves contrastive pre-training using positive and negative audio-video pairs to establish a foundational understanding of synchronization. Subsequently, the techniques include fine-tuning the model through a ranking-based approach using synthetic shifted synchronizations to introduce supervision for partial synchronization. A final fine-tuning step employs real-world dubbed audio as examples of partial synchronization. Furthermore, the disclosed techniques, at all stages of pre-training and fine-tuning, apply a Ranking Supervised Multi-Similarity (RSMS) loss function. This loss function incorporates hierarchical supervision through hard-sample mining to enforce ranking among perfectly synced, partially synced, and unsynced audio-visual pairs. During training, the techniques compute weighted loss terms for each mined category of hard samples. This computation enables a fine-grained assessment of synchronization quality across the continuum of synchronization.

One technical advantage of the disclosed techniques over the prior art is that the disclosed techniques enable the ranking and fine-grained assessment of partial synchronization in audio-visual content, which presented challenges under conventional contrastive learning approaches. More specifically, conventional lip-sync estimation models generate binary embedding spaces that distinguish only between perfectly synchronized and unsynchronized content. Such a limitation renders the evaluation of intermediate synchronization levels, in the context of dubbing, prohibitively difficult. The disclosed Ranking Supervised Multi-Similarity (RSMS) loss function forces the model to learn a continuous spectrum of synchronization quality. This enables the model to distinguish dubbed audio tracks from perfectly synchronized and unsynchronized audio tracks. The multi-stage training approach incorporates partially-synchronized training examples of increasing complexity at multiple stages. Such a strategy assists the lip-sync estimation model in learning a continuum of lip-sync synchronization. As a result, the disclosed training approach trains a lip-sync estimation model that is capable of automated estimation of dubbed content, a task that was previously technically challenging to implement.

Another technical advantage of the disclosed techniques over the prior art is that the disclosed techniques utilize partially-synchronized examples to increase the volume of training data. Conventional contrastive learning approaches enforce a binary classification between perfectly synchronized and unsynchronized content. Because the training procedure lacks an understanding of partially-synchronized content, partially synchronized content does not provide usefulness for training lip-sync estimation models in these approaches. The disclosed techniques make use of real-world partially-synchronized content with the RSMS loss function and the multi-stage training procedure. As a result, the disclosed techniques use partially-synchronized content more efficiently for training data and therefore generate more accurate and expressive lip-sync estimation models.

1. In some embodiments, a method for training lip-sync estimation models comprises obtaining video training data comprising a plurality of training videos and corresponding audio training data; selecting an anchor video from the plurality of training videos; identifying, with respect to the anchor video and based on a similarity evaluation generated by a machine learning (ML) model, a plurality of audio samples; generating a training loss from the plurality of audio samples; applying backpropagation from the training loss to update parameters of the ML model until a convergence criteria is satisfied; and generating a trained lip-sync estimation model based on the updated parameters.

2. The computer-implemented method of clause 1, wherein the plurality of audio samples comprises at least one of a hard positive audio sample, a hard negative audio sample, a hard dubbed audio sample with respect to a hard positive audio sample, or a hard dubbed audio sample with respect to a hard negative audio sample.

3. The computer-implemented method of any of clauses 1-2, wherein the similarity evaluation comprises generating, via the ML model, a similarity score for each combination of a training video from the plurality of training videos and a corresponding audio sample from the audio training data.

4. The computer-implemented method of any of clauses 1-3, wherein the similarity scores are arranged into a similarity matrix in which each element corresponds to a synchronization score for a combination of a training video from the plurality of training videos and corresponding audio sample from the audio training data.

5. The computer-implemented method of any of clauses 1-4, wherein identifying the plurality of audio samples comprises selecting one or more cases in which a similarity ranking generated by the ML model is incorrect for the anchor video.

6. The computer-implemented method of any of clauses 1-5, wherein generating the training loss comprises generating a ranking-supervised multi-similarity loss.

7. The computer-implemented method of any of clauses 1-6, wherein the ranking-supervised multi-similarity loss comprises a plurality of loss terms corresponding to categories of the plurality of audio samples and aggregated into the training loss.

8. The computer-implemented method of any of clauses 1-7, wherein applying backpropagation from the training loss to update the parameters of the ML model comprises performing an optimization algorithm to adjust the parameters.

9. The computer-implemented method of any of clauses 1-8, wherein the convergence criteria is satisfied when changes in the training loss across consecutive iterations are below a pre-defined threshold.

10. The computer-implemented method of any of clauses 1-9, wherein collecting the video training data further comprises extracting facial regions from the plurality of training videos, and collecting the audio training data comprises generating spectrogram representations of the audio samples.

11. In some embodiments, one or more non-transitory computer readable media store instructions that, when executed by one or more processors, cause the one or more processors train lip-sync estimation models, by performing the operations of obtaining video training data comprising a plurality of training videos and corresponding audio training data; selecting an anchor video from the plurality of training videos; identifying, with respect to the anchor video and based on a similarity evaluation generated by a machine learning (ML) model, a plurality of audio samples; generating a training loss from the plurality of audio samples; applying backpropagation from the training loss to update parameters of the ML model until a convergence criteria is satisfied; and generating a trained lip-sync estimation model based on the updated parameters.

12. The one or more non-transitory computer readable media of clause 11, wherein the convergence criterion is satisfied when a pre-defined number of training iterations has occurred.

13. The one or more non-transitory computer readable media of any of clauses 11-12, wherein the operations further comprise associating training audio labels with the audio training data to identify dubbed audio and indicate correspondence between audio samples and the plurality of training videos.

14. The one or more non-transitory computer readable media of any of clauses 11-13, wherein generating the trained lip-sync estimation model further comprises associating the trained lip-sync estimation model with convergence information indicating satisfaction of the convergence criterion.

15. The one or more non-transitory computer readable media of any of clauses 11-14, wherein the plurality of audio samples comprises at least one of a hard positive audio sample, a hard negative audio sample, a hard dubbed audio sample with respect to a hard positive audio sample, or a hard dubbed audio sample with respect to a hard negative audio sample.

16. The one or more non-transitory computer readable media of any of clauses 11-15, wherein the similarity evaluation comprises generating, via the ML model, a similarity score for each combination of a training video from the plurality of training videos and a corresponding audio sample from the audio training data.

17. The one or more non-transitory computer readable media of any of clauses 11-16, wherein the similarity scores are arranged into a similarity matrix in which each element corresponds to a synchronization score for a combination of a training video from the plurality of training videos and corresponding audio sample from the audio training data.

18. The one or more non-transitory computer readable media of any of clauses 11-17, wherein identifying the plurality of audio samples comprises selecting one or more cases in which a similarity ranking generated by the ML model is incorrect for the anchor video.

19. The one or more non-transitory computer readable media of any of clauses 11-18, wherein generating the training loss comprises generating a ranking-supervised multi-similarity loss.

20. In some embodiments, a computer system comprises one or more memories that include instructions, and one or more processors that are coupled to the one or more memories and that, when executing the instructions, are configured to train lip-sync estimation models, by performing the operations of obtaining video training data comprising a plurality of training videos and corresponding audio training data; selecting an anchor video from the plurality of training videos; identifying, with respect to the anchor video and based on a similarity evaluation generated by a machine learning (ML) model, a plurality of audio samples; generating a training loss from the plurality of audio samples; applying backpropagation from the training loss to update parameters of the ML model until a convergence criteria is satisfied, and generating a trained lip-sync estimation model based on the updated parameters.

21. In some embodiments, a method for performing multi-stage training of lip-sync estimation models comprises obtaining video training data comprising a plurality of training videos and corresponding audio training data; training a machine learning (ML) model for lip-sync estimation through a plurality of training stages, wherein each successive stage utilizes training data having greater synchronization complexity than a preceding training stage; updating parameters of the ML model based on results generated from the plurality of training stages; and generating a trained lip-sync estimation model based on the updated parameters of the ML model.

22. The computer-implemented method of clause 21, wherein a first training stage comprises training the ML model using positive audio samples and negative audio samples.

23. The computer-implemented method of any of clauses 21-22, wherein a training stage comprises generating pseudo-dubbed audio samples by temporally shifting positive audio samples and training the ML model using the positive audio samples, negative audio samples from the audio training data, and the pseudo-dubbed audio samples.

24. The computer-implemented method of any of clauses 21-23, wherein a training stage comprises training the ML model using positive audio samples, negative audio samples, and dubbed audio samples.

25. The computer-implemented method of any of clauses 21-24, further comprising, prior to training the ML model, extracting facial regions from the plurality of training videos.

26. The computer-implemented method of any of clauses 21-25, further comprising, prior to training the ML model, generating spectrogram representations of the audio training data.

27. The computer-implemented method of any of clauses 21-26, wherein positive audio samples from the audio training data comprise at least one of a hard positive audio sample, a hard negative audio sample, a hard dubbed audio sample with respect to a hard positive audio sample, or a hard dubbed audio sample with respect to a hard negative audio sample.

28. The computer-implemented method of any of clauses 21-27, wherein training the ML model in at least one stage comprises performing a ranking-supervised multi-similarity loss procedure.

29. The computer-implemented method of any of clauses 21-28, wherein the ranking-supervised multi-similarity loss procedure comprises: generating a plurality of loss terms corresponding to categories of audio samples from the audio training data, and aggregating the plurality of loss terms into a training loss.

30. The computer-implemented method of any of clauses 21-29, wherein dubbed audio samples comprise audio content exhibiting partial synchronization with a corresponding training video included in the plurality of training videos.

31. In some embodiments, one or more non-transitory computer readable media store instructions that, when executed by one or more processors, cause the one or more processors to perform multi-stage training of lip-sync estimation models, by performing the operations of obtaining video training data comprising a plurality of training videos and corresponding audio training data; training a machine learning (ML) model for lip-sync estimation through a plurality of training stages, wherein each successive stage utilizes training data having greater synchronization complexity than a preceding training stage; updating parameters of the ML model based on results generated from the plurality of training stages; and generating a trained lip-sync estimation model based on the updated parameters of the ML model.

32. The one or more non-transitory computer readable media of clause 31, wherein the operations further comprise, prior to training the ML model, associating training audio labels with the audio training data to identify dubbed audio samples and indicate correspondence between audio samples and the plurality of training videos.

33. The one or more non-transitory computer readable media of any of clauses 31-32, wherein generating the trained lip-sync estimation model further comprises associating the model with convergence information indicating satisfaction of a convergence criterion.

34. The one or more non-transitory computer readable media of any of clauses 31-33, wherein a training stage comprises adjusting synchronization complexity by varying a temporal shift applied to positive audio samples.

35. The one or more non-transitory computer readable media of any of clauses 31-34, wherein a first training stage comprises training the ML model using positive audio samples and negative audio samples.

36. The one or more non-transitory computer readable media of any of clauses 31-35, wherein a training stage comprises generating pseudo-dubbed audio samples by temporally shifting positive audio samples and training the ML model using the positive audio samples, negative audio samples from the audio training data, and the pseudo-dubbed audio samples.

37. The one or more non-transitory computer readable media of any of clauses 31-36, wherein a training stage comprises training the ML model using positive audio samples, negative audio samples, and dubbed audio samples.

38. The one or more non-transitory computer readable media of any of clauses 31-37, further comprising, prior to training the ML model, extracting facial regions from the plurality of training videos.

39. The one or more non-transitory computer readable media of any of clauses 31-38, further comprising, prior to training the ML model, generating spectrogram representations of the audio training data.

40. In some embodiments, a computer system comprises one or more memories that include instructions, and one or more processors that are coupled to the one or more memories and that, when executing the instructions, are configured to perform multi-stage training of lip-sync estimation models, by performing the operations of obtaining video training data comprising a plurality of training videos and corresponding audio training data; training a machine learning (ML) model for lip-sync estimation through a plurality of training stages, wherein each successive stage utilizes training data having greater synchronization complexity than a preceding training stage; updating parameters of the ML model based on results generated from the plurality of training stages, and generating a trained lip-sync estimation model based on the updated parameters of the ML model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A method for performing multi-stage training of lip-sync estimation models, the method comprising:
obtaining video training data comprising a plurality of training videos and corresponding audio training data;
training a machine learning (ML) model for lip-sync estimation through a plurality of training stages, wherein each successive stage utilizes training data having greater synchronization complexity than a preceding training stage;
updating parameters of the ML model based on results generated from the plurality of training stages; and
generating a trained lip-sync estimation model based on the updated parameters of the ML model.

2. The computer-implemented method of claim 1, wherein a first training stage comprises training the ML model using positive audio samples and negative audio samples.

3. The computer-implemented method of claim 1, wherein a training stage comprises generating pseudo-dubbed audio samples by temporally shifting positive audio samples and training the ML model using the positive audio samples, negative audio samples from the audio training data, and the pseudo-dubbed audio samples.

4. The computer-implemented method of claim 1, wherein a training stage comprises training the ML model using positive audio samples, negative audio samples, and dubbed audio samples.

5. The computer-implemented method of claim 1, further comprising, prior to training the ML model, extracting facial regions from the plurality of training videos.

6. The computer-implemented method of claim 1, further comprising, prior to training the ML model, generating spectrogram representations of the audio training data.

7. The computer-implemented method of claim 1, wherein positive audio samples from the audio training data comprise at least one of a hard positive audio sample, a hard negative audio sample, a hard dubbed audio sample with respect to a hard positive audio sample, or a hard dubbed audio sample with respect to a hard negative audio sample.

8. The computer-implemented method of claim 1, wherein training the ML model in at least one stage comprises performing a ranking-supervised multi-similarity loss procedure.

9. The computer-implemented method of claim 8, wherein the ranking-supervised multi-similarity loss procedure comprises:
generating a plurality of loss terms corresponding to categories of audio samples from the audio training data, and
aggregating the plurality of loss terms into a training loss.

10. The computer-implemented method of claim 1, wherein dubbed audio samples comprise audio content exhibiting partial synchronization with a corresponding training video included in the plurality of training videos.

11. One or more non-transitory computer readable media storing instructions that, when executed by one or more processors, cause the one or more processors to perform multi-stage training of lip-sync estimation models, by performing the operations of:
obtaining video training data comprising a plurality of training videos and corresponding audio training data;
training a machine learning (ML) model for lip-sync estimation through a plurality of training stages, wherein each successive stage utilizes training data having greater synchronization complexity than a preceding training stage;
updating parameters of the ML model based on results generated from the plurality of training stages; and
generating a trained lip-sync estimation model based on the updated parameters of the ML model.

12. The one or more non-transitory computer readable media of claim 11, wherein the operations further comprise, prior to training the ML model, associating training audio labels with the audio training data to identify dubbed audio samples and indicate correspondence between audio samples and the plurality of training videos.

13. The one or more non-transitory computer readable media of claim 11, wherein generating the trained lip-sync estimation model further comprises associating the model with convergence information indicating satisfaction of a convergence criterion.

14. The one or more non-transitory computer readable media of claim 11, wherein a training stage comprises adjusting synchronization complexity by varying a temporal shift applied to positive audio samples.

15. The one or more non-transitory computer readable media of claim 11, wherein a first training stage comprises training the ML model using positive audio samples and negative audio samples.

16. The one or more non-transitory computer readable media of claim 11, wherein a training stage comprises generating pseudo-dubbed audio samples by temporally shifting positive audio samples and training the ML model using the positive audio samples, negative audio samples from the audio training data, and the pseudo-dubbed audio samples.

17. The one or more non-transitory computer readable media of claim 11, wherein a training stage comprises training the ML model using positive audio samples, negative audio samples, and dubbed audio samples.

18. The one or more non-transitory computer readable media of claim 11, further comprising, prior to training the ML model, extracting facial regions from the plurality of training videos.

19. The one or more non-transitory computer readable media of claim 11, further comprising, prior to training the ML model, generating spectrogram representations of the audio training data.

20. A computer system, comprising:
one or more memories that include instructions; and
one or more processors that are coupled to the one or more memories and, when executing the instructions, are configured to perform multi-stage training of lip-sync estimation models, by performing the operations of:
obtaining video training data comprising a plurality of training videos and corresponding audio training data;
training a machine learning (ML) model for lip-sync estimation through a plurality of training stages, wherein each successive stage utilizes training data having greater synchronization complexity than a preceding training stage;
updating parameters of the ML model based on results generated from the plurality of training stages; and
generating a trained lip-sync estimation model based on the updated parameters of the ML model.
